(19) United States
(12) Patent Application Publication
(10) Pub. No.: US 2018/0315041 A1
(43) Pub. Date: Nov. 1, 2018

(54) Method of Automated Gift Card/Coupon Purchasing and Input Upon Checkout

(71) Applicant: Justin Wynn, Broomfield, CO (US)

(72) Inventor: Justin Wynn, Broomfield, CO (US)

(21) Appl. No.: 15/966,361

(22) Filed: Apr. 30, 2018

Related U.S. Application Data
(60) Provisional application No. 62/492,184, filed on Apr. 30, 2017.

(51) Int. Cl. G06Q 20/34; G06Q 30/06; G06Q 20/36

(52) U.S. Cl. CPC G06Q 20/351; G06Q 20/363; G06Q 30/0601

(57) ABSTRACT

A computer-implemented method for applying at least one gift card to a purchase from an online e-commerce site includes: providing a gift card database comprising at least a first gift card associated with a first e-commerce site and a second gift card associated with a second e-commerce site; on a checkout page of the online e-commerce site displayed on a user device, detecting a gift card input field; receiving data from the user device corresponding to an identity of the e-commerce site displayed on the user device; determining whether one of the at least first gift card and the second gift card on the gift card database corresponds to the identity of the e-commerce site displayed on the user device; and providing data corresponding to one of the at least first gift card and second gift card to the user device to be applied to the purchase from the online e-commerce site.

### CROSS-REFERENCE TO RELATED APPLICATION

This application claims priority to U.S. Provisional Patent Application No. 62/492,184 filed on Apr. 30, 2017, for a Method of Automated Gift Card/Coupon Purchasing and Input on Checkout, the contents of which are incorporated herein by reference in its entirety.

### FIELD

This disclosure relates to the field of e-commerce transactions. More particularly, this disclosure relates to a method of automatic gift card input on checkout for e-commerce purchases.

### BACKGROUND

As the Internet progresses, so does online shopping. Online companies are taking over traditional methods of physically entering a store and making a purchase. With easy to use shopping carts, rating systems, and coupon codes, users are able to compare prices and obtain the best savings. Online shopping also allows users to buy items from different countries.

When shopping online, customers are typically looking to save money by having the ability to input coupon codes and gift certificates. Additionally, many shoppers receive gift cards that are never used. Online businesses allow those shoppers to sell their gift cards for money and at a discounted price. The online businesses then sell the same gift cards at a marked-up price, but slightly below the price listed on the gift card itself.

While users are able to purchase various gift cards, often that process must be completed separately from a process of checking out and purchasing goods from an online retailer. What is needed, therefore, is a system and method of integrating the purchase of a gift card during a check out process of an online retailer.

### SUMMARY

The above and other needs are met by a system and method of integrating the purchase of a gift card during a check out process of an online retailer. In a first aspect, a computer-implemented method for applying at least one gift card to a purchase from an online e-commerce site includes: providing a gift card database comprising at least a first gift card associated with a first e-commerce site and a second gift card associated with a second e-commerce site; on a checkout page of the online e-commerce site displayed on a user device, detecting a gift card input field; receiving data from the user device corresponding to an identity of the e-commerce site displayed on the user device; determining whether one of the at least first gift card and the second gift card on the gift card database corresponds to the identity of the e-commerce site displayed on the user device; and providing data corresponding to one of the at least first gift card and second gift card to the user device to be applied to the purchase from the online e-commerce site.

In one embodiment, the method further includes providing instructions to the user device to input data corresponding to one of the at least first gift card and second gift card into the gift card input field.

In another embodiment, the at least first gift card and second gift card have a retail value price and a re-purchase price.

In yet another embodiment, the method further includes transmitting a request for payment of the re-purchase price to the user device when one of the at least first gift card and second gift card corresponds to the identity of the e-commerce site displayed on the user device.

In one embodiment, the method further includes providing instructions to the user device to display a prompt for payment when one of the at least first gift card and second gift card corresponds to the identity of the e-commerce site displayed on the user device.

In another embodiment, the e-commerce site is displayed on a browser of the user device. In yet another embodiment, the method further includes automatically inputting data corresponding to the at least first gift card or second gift card through a browser extension operable on the user device.

In one embodiment, the method further includes providing a user database comprising payment information corresponding to a plurality of users. In another embodiment, the method further includes receiving data from the user device corresponding to a total price of the purchase on the online e-commerce site. In yet another embodiment, the method further includes determining whether one of the at least first gift card and second gift card corresponds to the total price of the purchase on the online e-commerce site.

In one embodiment, data corresponding to one of the at least first gift card and second gift card is selected from the group consisting of a gift card number and a percentage discount code.

In another embodiment, the method further includes verifying funds associated with the at least first gift card or at least second gift card with a retail system.

In a second aspect, a computer-implemented method of completing a transaction on an e-commerce site includes: providing a gift card database comprising data associated with a plurality of gift cards; on a checkout page of the online e-commerce site displayed on a user device, detecting a gift card input field; receiving data from the user device corresponding to an identity of the e-commerce site displayed on the user device; determining whether one or more of the gift cards on the gift card database corresponds to the identity of the e-commerce site displayed on the user device; providing data of one of the gift cards on the gift card database to the user device when one of the gift cards corresponds to the identity of the e-commerce site displayed on the user device.

In one embodiment, the method further includes providing instructions to the user device to input data corresponding to the gift card corresponding to the identity of the e-commerce site displayed on the user device into the gift card input field.

In another embodiment, the e-commerce site is displayed on a browser of the user device. In yet another embodiment, the method further includes automatically inputting gift card data corresponding to the identity of the e-commerce site through a browser extension operable on the user device.

In a third aspect, a computer-implemented method of completing a transaction on an e-commerce site includes: providing a gift card database comprising data associated with a plurality of gift cards; on a checkout page of the online e-commerce site displayed on a browser of a user device, detecting a gift card input field; receiving data from the user device corresponding to an identity of the e-commerce site displayed on the user device; determining whether one or more of the gift cards on the gift card database corresponds to the identity of the e-commerce site displayed on the user device; providing data of one of the gift cards on the gift card database to the user device when one of the gift cards corresponds to the identity of the e-commerce site displayed on the user device; and providing instructions to the user device to input data corresponding to the gift card corresponding to the identity of the e-commerce site displayed on the user device into the gift card input field through a browser extension operable on the user device.

### BRIEF DESCRIPTION OF THE DRAWINGS

Further features, aspects, and advantages of the present disclosure will become better understood by reference to the following detailed description, appended claims, and accompanying figures, wherein elements are not to scale so as to more clearly show the details, wherein like reference numbers indicate like elements throughout the several views, and wherein:

FIG. 1 is a flowchart showing registration of a user account according to one embodiment of the present disclosure;

FIG. 2 is a flowchart illustrating a method of automated gift card transactions according to one embodiment of the present disclosure;

FIG. 3 is a flowchart of an exemplary transaction using a method of automated gift card transactions according to one embodiment of the present disclosure;

FIG. 4 shows a checkout page of a web site or online store including a gift card/coupon input field according to one embodiment of the present disclosure;

FIG. 5 is a diagram of a system of automated gift card purchasing and input according to one embodiment of the present disclosure; and

FIG. 6 is a schematic illustration of an exemplary user device according to one embodiment of the present disclosure.

### DETAILED DESCRIPTION

Various terms used herein are intended to have particular meanings. Some of these terms are defined below for the purpose of clarity. The definitions given below are meant to cover all forms of the words being defined (e.g., singular, plural, present tense, past tense). If the definition of any term below diverges from the commonly understood and/or dictionary definition of such term, the definitions below control.

Embodiments of the present disclosure may take the form of a set of instructions, such as a computer program product, for causing a processor and/or computing device to perform a desired function, stored on a computer-readable storage medium having computer-readable program code embodied in the storage medium. Any suitable computer-readable storage medium may be utilized, including, but not limited to, hard disk drive, CD-ROM, optical storage devices, magnetic storage devices, USB memory devices, any appropriate volatile or non-volatile memory system, and the like or any combination thereof. The present technology may take the form of a downloadable and/or cloud-based non-downloadable computer program product and/or methods. While reference is made to an extension of plugin associated with a browser on a user device, it is also understood that embodiments of the present disclosure may also be implemented as a software application installed locally on the user device, such as downloadable software installed on a mobile device of a user.

Embodiments of the present disclosure include a system and method capable of detecting a shopping cart or checkout page including an input field for a gift card or coupon code. When a user pays for the discounted gift card/coupon, which may be performed automatically, the gift card/coupon may be automatically applied during checkout. Systems and methods of the present disclosure are preferably performed using an extension to a browser of a user's device.

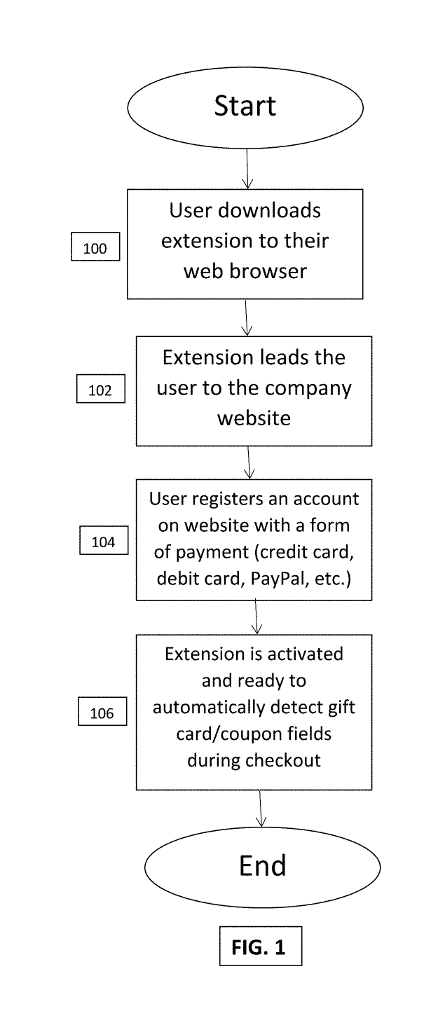

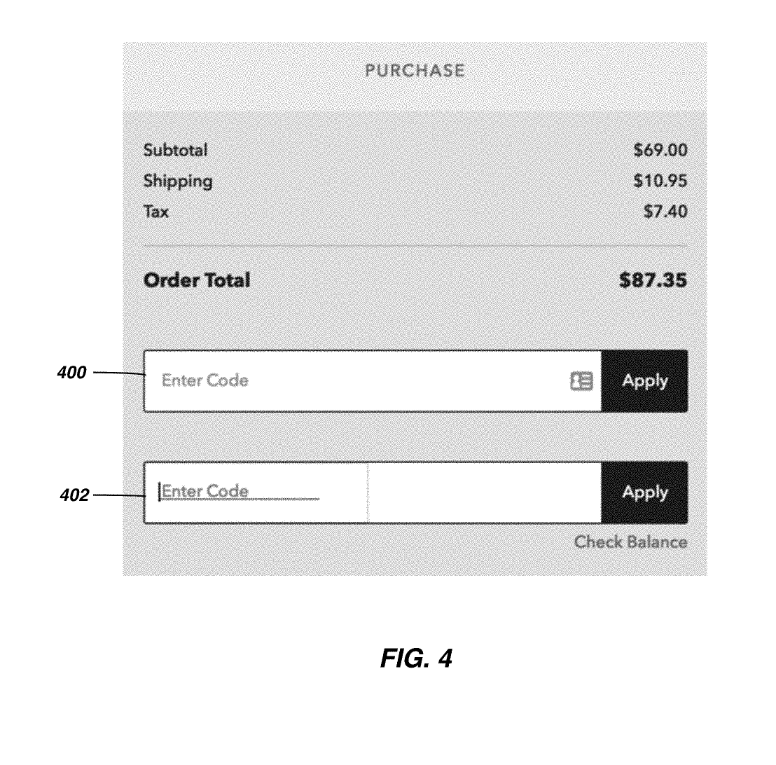

Referring now to FIG. 1, a user first registers an account which may optionally include payment information of the user. Alternatively, a user may manually enter payment information during a checkout process. Further, the user installs a plugin or browser extension when embodiments of the present disclosure are implanted on a user device as described in greater detail below. The user may first download and install a plugin on a browser of the user device in step 100. Installation of the plugin may prompt the user to visit a website (step 102) and create an account. Subsequently, the user may input a form of payment that is to be associated with the user's account (step 104). Alternatively, the user may register an account on the website and a plugin or extension subsequently downloaded and installed on the user device. After registration of the user, the plugin or extension on the user device is activated and configured to detect gift card/coupon fields 400 and 402 (FIG. 4) on a shopping cart page displayed on the user device (step 106). Codes capable of being entered into the gift card/coupon field include gift card data, percentage coupons, rebates, and other similar data. Data corresponding to gift cards/coupons is stored in a database to be input into fields of the shopping cart or checkout page as described in greater detail below.

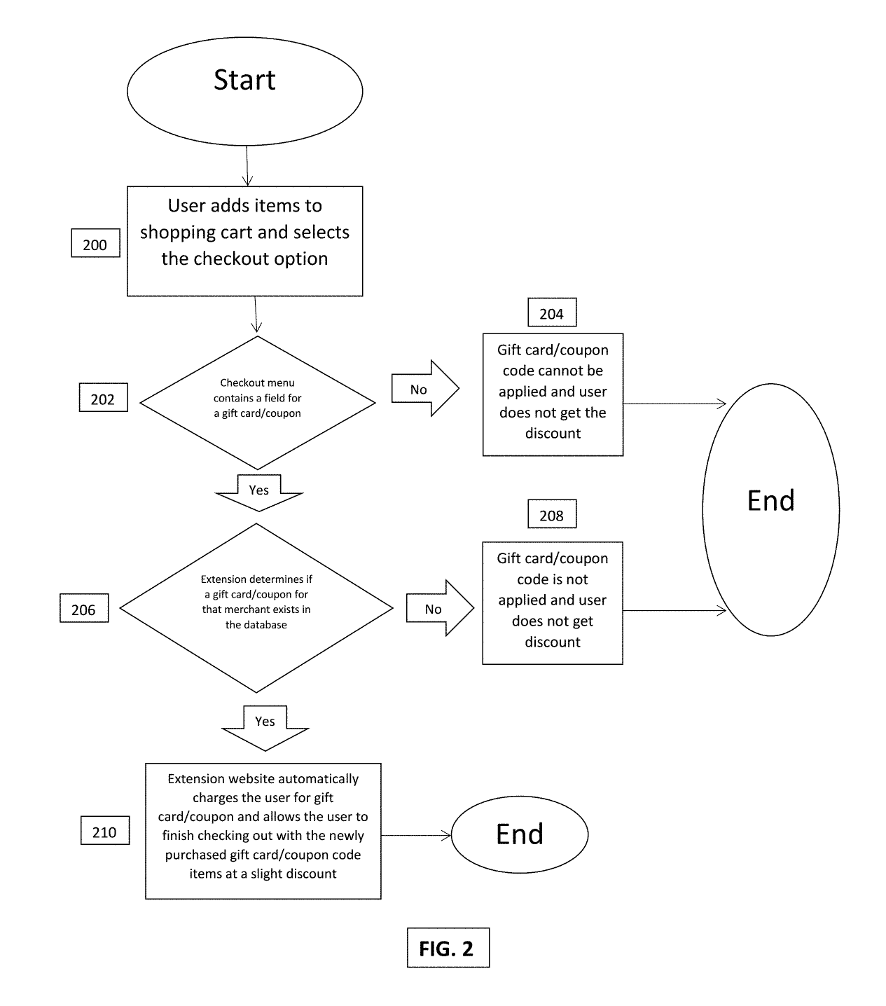

FIG. 2 shows a flowchart of an automated process of a system and method of detecting a shopping cart or checkout page including an input field for a gift card or coupon code. Methods of FIG. 2 are preferably performed after a user creates a user account according to the steps of FIG. 1 and described above. After a user has selected items for purchase on a website or online store, the user begins a checkout process to purchase the items selected by the user and that have been preferably added to an online shopping cart of the user. In some embodiments, a user may be prompted to input data related to a gift card/coupon prior to checking out (step 200).

When a checkout or purchase page of the website or online store is displayed to the user on the user device, the installed plugin or extension associated with a browser of the user's device determines whether a gift card/coupon field is available (step 202). If no gift card/coupon input field is detected on the checkout page displayed on the user's device, the extension or plugin installed on the user's device, then no gift card/coupon data is retrieved to be entered into the checkout page (step 204). If a gift card/coupon data input field is detected on the checkout page, a database of gift card/coupon data is queried to determine if data for a gift card/coupon is available for purchase that corresponds to the website or online store displaying the gift card/coupon input field (step 206). If no gift card/coupon data is located for a gift card/coupon corresponding to the website or online store displaying the gift card/coupon input field, no data is provided to the user device for input into the gift card/coupon field (step 208). If gift card/coupon data is found corresponding to the website or online store displaying the gift card/coupon input field, a notification is displayed to the user on the user device and data of the corresponding gift card/coupon is automatically entered into the gift card/coupon input field of the checkout page. The user is then able to complete a purchase with the entered gift card/coupon data. The user's account is charged for the purchase of the gift card/coupon data, and the user is able to check out and complete a purchase at a discounted amount instead of full price (step 210).

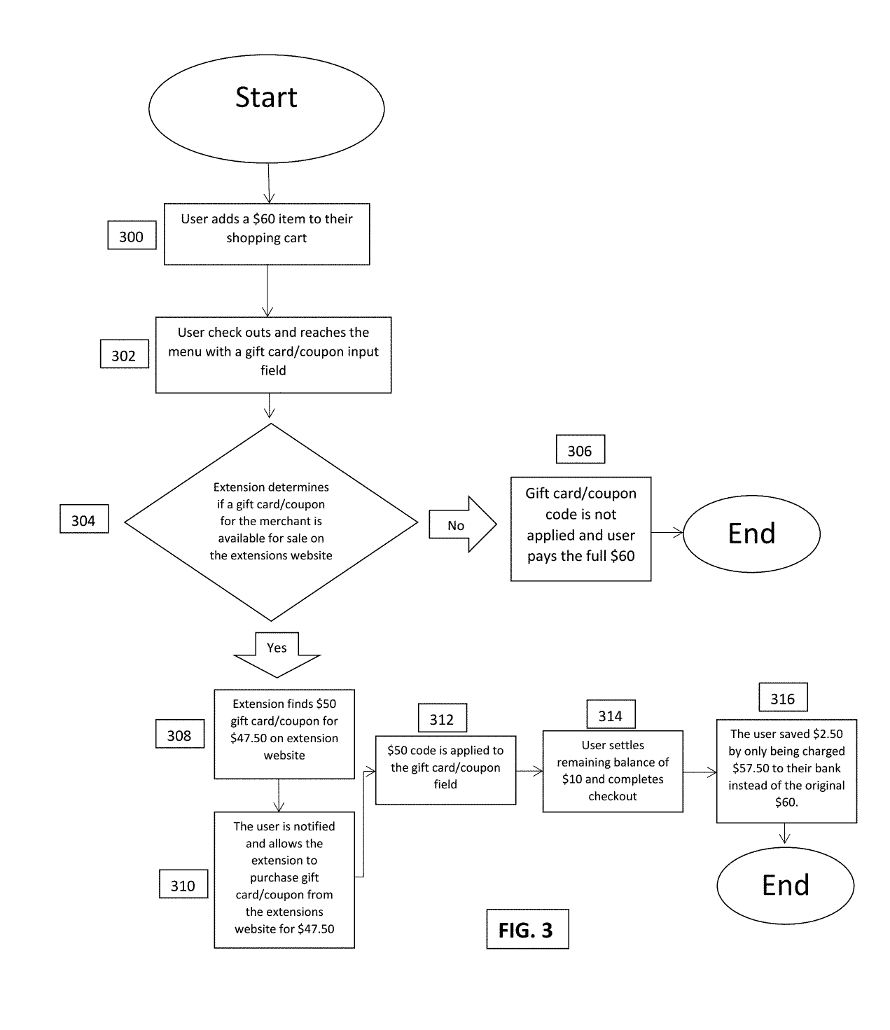

FIG. 3 illustrates a flowchart of an exemplary process in accordance with embodiments of the present disclosure. In the example of FIG. 3, the user adds an item costing $60 to a shopping cart of the user (step 300). When the user navigates to a checkout page, the extension or plugin associated with a browser of the user device determines whether an input field for gift card/coupon data is available to receive input data of a gift card/coupon (step 302). In the example of FIG. 3, an input field for a gift card/coupon code is automatically assumed to exist on the checkout page. A database of gift card/coupon data is queried to determine if a gift card/coupon is available for purchase for the merchant corresponding to the checkout page. (step 304). If no available gift card/coupon is located, no code or other data is entered into the input field on the checkout page and the user pays $60 for the item (step 306).

If an available gift card/coupon is located on the database of gift card/coupon data, the user may purchase the available gift card/coupon and data of the gift card/coupon is entered into the gift card/coupon input field on the checkout page such that the gift card/coupon is applied to the user's purchase. In the example of FIG. 3, a $50 available gift card/coupon is located and is available for purchase by the user for a price of $47.50 (step 308). A notification is displayed to the user on the user device for approval by the user for purchase of the gift card/coupon (step 310). The user is charged a purchase price for the gift card/coupon and is billed according to payment information associated with the user's account (step 312). Data of the gift card/coupon is automatically entered, and the $50 gift card/coupon is automatically applied as the user proceeds to payment (step 314). The user completes purchase of the items through the website or online store by paying the remaining $10 balance after the gift card is applied to complete the checkout process (step 316). In the example of FIG. 3, the user has saved $2.50 by paying a total of $57.50 for purchase of the gift card and remaining balance due to the retailer as opposed to the original $60 price of the item purchased by the user.

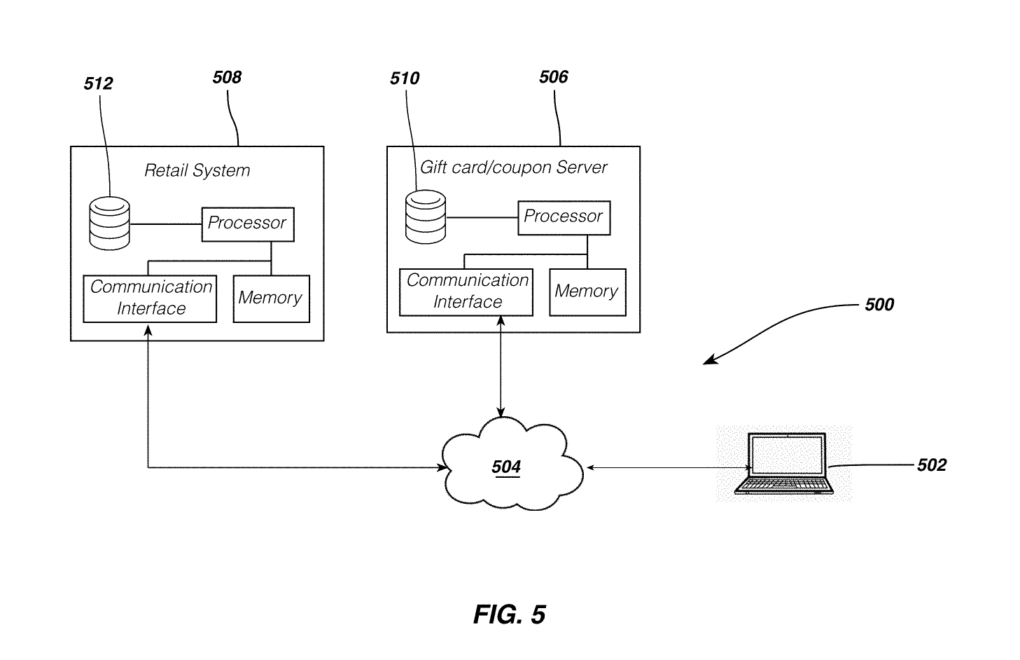

Referring now to FIG. 5, an automated gift card system 500 is shown including a user device 502 in electronic communication with a gift card/coupon server 506 over a network 504, such as the Internet. The user device 502 is also in electronic communication with a retail system 508, the retail system associated with a website or online store having items available for purchase online. The gift card/coupon server 506 communicates with the user device 502 via a communication interface of the gift card/coupon server 506. Data associated with a plurality of gift cards, such as gift card numbers, discount codes, percentage discount codes, and other gift card data described in the methods above are stored in a database 510 of the gift card/coupon server 506. Gift card data includes data associated with at least a first gift card and a second gift card, and preferably includes data corresponding to gift cards associated with multiple retailers. The gift card/coupon server 506 includes memory for storing computer executable instructions and related software for communicating gift card data on the database 510 with the user device 502, and further includes a processor in communication with the memory for executing instructions on the memory.

The processor on the gift card/coupon server 506 receives data from the user device 502, such as an identity of a website or online store displayed on the user device 502 and determines whether gift card/coupon data stored in the database 510 corresponds to the website or online store determined to be displayed on the user device 502. If data corresponding to a gift card/coupon is located that corresponds to the website or online store displayed on the user device 502, the gift card/coupon server 506 transmits data of the gift card/coupon to the user device 502 to be applied to the purchase of goods from the website or online store displayed on the user device 502. Gift card/coupon data from the gift card/coupon server may be provided to the user device 502 along with instructions to input gift card/coupon data into a gift card/coupon field displayed on a browser of the user device 502.

The gift card/coupon server 506 may further be in electronic communication with the retail system 508, as shown in FIG. 5. The gift card/coupon server 506 may be in communication with the retail system 508 to verify data related to a gift card/coupon to be purchased by a user through the user device 502. For example, prior to the user purchasing a gift card from the gift card/coupon server 506 (FIG. 2, step 210), the gift card/coupon server 506 may verify funds available for a particular gift card/coupon with the retail system 508. The gift card/coupon server 506 may transmit data corresponding to a gift card/coupon to be purchased by the user to the retail system 508. The retail system 508 verifies an amount available for the gift card/coupon, and if the gift card/coupon is verified the gift card/coupon is subsequently sold to the user.

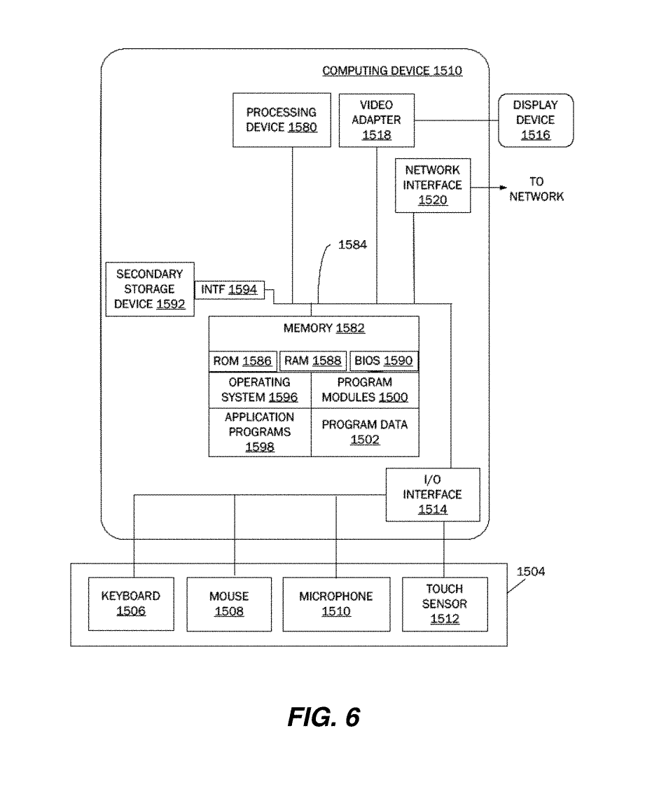

Referring to FIG. 6, examples of computing devices suitable for the user device 502 include a desktop computer, a laptop computer, a tablet computer, a mobile computing device (such as a smart phone, a tablet device, or other mobile devices), or other devices configured to process digital instructions.

The system memory 1582 includes read only memory 1586 and random-access memory 1588. A basic input/output system 1590 containing the basic routines that act to transfer information within computing device 1510, such as during start up, is typically stored in the read only memory 1586.

The computing device 1510 also includes a secondary storage device 1592 in some embodiments, such as a hard disk drive, for storing digital data. The secondary storage device 1592 is connected to the system bus 1584 by a secondary storage interface 1594. The secondary storage devices 1592 and their associated computer readable media provide nonvolatile storage of computer readable instructions (including application programs and program modules), data structures, and other data for the computing device 1510.

Although the exemplary environment described herein employs a hard disk drive as a secondary storage device, other types of computer readable storage media are used in other embodiments. Examples of these other types of computer readable storage media include magnetic cassettes, flash memory cards, digital video disks, Bernoulli cartridges, compact disc read only memories, digital versatile disk read only memories, random access memories, or read only memories. Some embodiments include non-transitory media. Additionally, such computer readable storage media can include local storage or cloud-based storage.

A number of program modules can be stored in secondary storage device 1592 or memory 1582, including an operating system 1596, one or more application programs 1598, other program modules 1500 (such as the software engines described herein), and program data 1502. The computing device 1510 can utilize any suitable operating system, such as Microsoft Windows™, Google Chrome™, Apple OS, Linux, Unix, and any other operating system suitable for a computing device. Other examples can include Microsoft, Google, or Apple operating systems, or any other suitable operating system used in computing devices.

In some embodiments, a user provides inputs to the computing device 1510 through one or more input devices 1504. Examples of input devices 1504 include a keyboard 1506, mouse 1508, microphone 1510, and touch sensor 1512 (such as a touchpad or touch sensitive display). Other embodiments include other input devices 1504. The input devices are often connected to the processing device 1580 through an input/output interface 1514 that is coupled to the system bus 1584. These input devices 1504 can be connected by any number of input/output interfaces, such as a parallel port, serial port, game port, or a universal serial bus. Wireless communication between input devices and the interface 1514 is possible as well, and includes infrared, BLUETOOTH® wireless technology, 802.11a/b/g/n, cellular, or other radio frequency communication systems in some possible embodiments.

In this example embodiment, a display device 1516, such as a monitor, liquid crystal display device, projector, or touch sensitive display device, is also connected to the system bus 1584 via an interface, such as a video adapter 1518. In addition to the display device 1516, the computing device 1510 can include various other peripheral devices (not shown), such as speakers or a printer.

When used in a local area networking environment or a wide area networking environment (such as the Internet), the computing device 1510 is typically connected to a network through a network interface 1520, such as an Ethernet interface. Other possible embodiments use other communication devices. For example, some embodiments of the computing device 1510 include a modem for communicating across the network.

The computing device 1510 typically includes at least some form of computer readable media. Computer readable media includes any available media that can be accessed by the computing device 1510. By way of example, computer readable media include computer readable storage media and computer readable communication media.

Computer readable storage media includes volatile and nonvolatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device 1510.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

The computing device illustrated in FIG. 6 is also an example of programmable electronics, which may include one or more such computing devices, and when multiple computing devices are included, such computing devices can be coupled together with a suitable data communication network so as to collectively perform the various functions, methods, or operations disclosed herein.

The system and method of automated gift card purchasing and input described herein advantageously allows a user to locate and apply gift card or coupons during the purchase of goods by the user from a website or online store. Gift cards are automatically located and matched with an identity of the website or online store. The user may then purchase the gift card or coupon, and data of the purchased gift card/coupon is automatically entered into a gift card/coupon input field on the website or online store. Further, gift cards of interest are automatically located for the user without requiring the user to navigate away from a checkout page of the website or online store to purchase gift cards from third parties.

The foregoing description of preferred embodiments of the present disclosure has been presented for purposes of illustration and description. The described preferred embodiments are not intended to be exhaustive or to limit the scope of the disclosure to the precise form(s) disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the concepts revealed in the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

What is claimed is:

1. A computer-implemented method for applying at least one gift card to a purchase from an online e-commerce site, comprising:
providing a gift card database comprising at least a first gift card associated with a first e-commerce site and a second gift card associated with a second e-commerce site;
on a checkout page of the online e-commerce site displayed on a user device, detecting a gift card input field;
receiving data from the user device corresponding to an identity of the e-commerce site displayed on the user device;
determining whether one of the at least first gift card and the second gift card on the gift card database corresponds to the identity of the e-commerce site displayed on the user device;
providing data corresponding to one of the at least first gift card and second gift card to the user device to be applied to the purchase from the online e-commerce site.

2. The method of claim 1, further comprising providing instructions to the user device to input data corresponding to one of the at least first gift card and second gift card into the gift card input field.

3. The method of claim 1, wherein the at least first gift card and second gift card have a retail value price and a re-purchase price.

4. The method of claim 3, further comprising transmitting a request for payment of the re-purchase price to the user device when one of the at least first gift card and second gift card corresponds to the identity of the e-commerce site displayed on the user device.

5. The method of claim 1, further comprising providing instructions to the user device to display a prompt for payment when one of the at least first gift card and second gift card corresponds to the identity of the e-commerce site displayed on the user device.

6. The method of claim 1, wherein the e-commerce site is displayed on a browser of the user device.

7. The method of claim 1, further comprising automatically inputting data corresponding to one of the at least first gift card and second gift card through a browser extension operable on the user device.

8. The method of claim 1, further comprising providing a user database comprising payment information corresponding to a plurality of users.

9. The method of claim 1, further comprising receiving data from the user device corresponding to a total price of the purchase on the online e-commerce site.

10. The method of claim 9, further comprising determining whether one of the at least first gift card and second gift card corresponds to the total price of the purchase on the online e-commerce site.

11. The method of claim 1, wherein data corresponding to one of the at least first gift card and second gift card is selected from the group consisting of a gift card number, a percentage discount code, and a rebate code.

12. The method of claim 1, further comprising verifying funds associated with the at least first gift card or at least second gift card with a retail system.

13. A computer-implemented method of completing a transaction on an e-commerce site, comprising:
providing a gift card database comprising data associated with a plurality of gift cards;
on a checkout page of the online e-commerce site displayed on a user device, detecting a gift card input field;
receiving data from the user device corresponding to an identity of the e-commerce site displayed on the user device;
determining whether one or more of the gift cards on the gift card database corresponds to the identity of the e-commerce site displayed on the user device;
providing data of one of the gift cards on the gift card database to the user device when one of the gift cards corresponds to the identity of the e-commerce site displayed on the user device.

14. The method of claim 13, further comprising providing instructions to the user device to input data corresponding to the gift card corresponding to the identity of the e-commerce site displayed on the user device into the gift card input field.

15. The method of claim 13, wherein the e-commerce site is displayed on a browser of the user device.

16. The method of claim 15, further comprising automatically inputting gift card data corresponding to the identity of the e-commerce site through a browser extension operable on the user device.

17. A computer-implemented method of completing a transaction on an e-commerce site, comprising:
providing a gift card database comprising data associated with a plurality of gift cards;
on a checkout page of the online e-commerce site displayed on a browser of a user device, detecting a gift card input field;
receiving data from the user device corresponding to an identity of the e-commerce site displayed on the user device;
determining whether one or more of the gift cards on the gift card database corresponds to the identity of the e-commerce site displayed on the user device;
providing data of one of the gift cards on the gift card database to the user device when one of the gift cards corresponds to the identity of the e-commerce site displayed on the user device;
providing instructions to the user device to input data corresponding to the gift card corresponding to the identity of the e-commerce site displayed on the user device into the gift card input field through a browser extension operable on the user device.
